(19) United States
(12) Patent Application Publication
(10) Pub. No.: US 2017/0149689 A1
(43) Pub. Date: May 25, 2017

(54) LOCATION-BASED PROVISIONING OF DIGITAL RESOURCES IN A SMART HOSPITALITY SYSTEM

(71) Applicant: Arryved, Inc., Nederland, CO (US)

(72) Inventors: David Lee Norman, Nederland, CO (US); Thomas Wrensch, Boulder, CO (US)

(21) Appl. No.: 15/357,626

(22) Filed: Nov. 21, 2016

Related U.S. Application Data
(60) Provisional application No. 62/257,979, filed on Nov. 20, 2015.

(51) Int. Cl. H04L 12/911; H04L 29/08

(52) U.S. Cl. CPC H04L 47/82; H04L 67/18

(57) ABSTRACT

A method and system for providing location-based provisioning of digital resources to target computing devices based on the location of the target computing devices with respect to a geographical location. The system may employ predictive caching of digital resources on the target computing device when a broad encounter occurs between the target computing device and the geographical location such as when the target computing device is located within a zone surrounding the geographical location. The system further locates a target computing device within the confines of a geographical location and may provide detailed location information to entities associated with the geographical location to locate the user of the target computing device. The system further allows for the user of target computing device to interact with digital resources to send messages to entities associated with the geographical location such as messages including a photograph of the user.

### CROSS-REFERENCE TO RELATED APPLICATIONS

This application claims priority and benefit under 35 U.S.C. §119 to U.S. application Ser. No. 62/257,979, entitled “Location-Based Provisioning of Digital Resources,” filed on Nov. 20, 2015, and incorporated by reference in its entirety.

### FIELD

Implementations disclosed herein relate, in general, to a system and method for location-based provision of digital resources, and, more particularly, to a system and method allowing an in-person services provider to select and configure digital resources for presentation on a target computing device of a service guest if the location of the target computing device satisfies a location condition.

### BACKGROUND

Accurate and efficient location-based provisioning of digital resources to target computing devices presents challenges relating to the selection and configuration of the digital resources, efficient identification of target devices for provisioning, and continuing interaction with the digital resources after provisioning. Concerns including efficient use of available bandwidth and computing resources, intuitive management of the digital resources, and quality of user experience magnify these challenges. Especially in the area of in-person service providers, there is a need for efficient and configurable digital resource communications with service guests that meet the aforementioned challenges.

### SUMMARY

Implementations described herein address these challenges by providing a smart hospitality apparatus and methods for location-based provisioning of digital resources including one or more host servers, one or more digital resource specification devices, and one or more target computing devices that may be provisioned with digital resources when the one or more target computing devices report physical locations that satisfy a condition with respect to a geographical location. Also disclosed herein are systems and methods for determining the locations of the target computing devices, prioritizing their provisioning with digital resources to improve managing interactions with the digital resources by users of the provisioned target computing devices, and reporting summary and statistical data relating to geographical locations, behavior choices, and a variety of sets of data.

This Summary is provided to introduce a selection of concepts in a simplified form that will be further described below more fully in the Detailed Description section. This Summary is not intended to identify key features or essential elements of the claimed subject matter, nor is it intended to limit the scope of the claimed subject matter as other implementations are also described and claimed herein.

### BRIEF DESCRIPTION OF THE DRAWINGS

A further understanding of the nature and advantages of the present technology may be realized by reference to the figures, which are described in the remaining portion of the specification.

FIGS. 1A-1C are block diagrams of an example communications network and system on which a smart hospitality location-based digital resource provisioning system and method may operate in accordance with the embodiments described herein;

FIG. 2 depicts a new profile screen of an example target computing device application in a smart hospitality system;

FIG. 3 depicts a profile setup screen of an example target computing device application in a smart hospitality system;

FIG. 4 depicts a navigation screen of an example target computing device application in a smart hospitality system;

FIG. 5 depicts an inventory list screen of an example target computing device application in a smart hospitality system;

FIG. 6 depicts an inventory description screen of an example target computing device application in a smart hospitality system;

FIG. 7 depicts a filter screen of an example target computing device application in a smart hospitality system;

FIG. 8 depicts an order screen of an example target computing device application in a smart hospitality system;

FIG. 9 depicts a running tab screen of an example target computing device application in a smart hospitality system;

FIG. 10 depicts a tab payment screen of an example target computing device application in a smart hospitality system;

FIG. 11 depicts a receipt screen of an example target computing device application in a smart hospitality system;

FIG. 12 depicts social networking screen of an example target computing device application in a smart hospitality system;

FIG. 13 depicts social ranking screen of an example target computing device application in a smart hospitality system;

FIG. 14 depicts a digital resource message received screen of an example target computing device application in a smart hospitality system; and

FIG. 15 illustrates an example schematic of an example target computing device suitable for being provisioned with digital resources in a smart hospitality system.

FIG. 16 illustrates example operations for location-based provisioning of digital resources.

### DETAILED DESCRIPTION

Digital resources are a type of resource provisioned to a target computing device 116 and presented to a user 114 via a target computing device application 126. Digital resources may include but are not limited to: video, text, digital images including animated GIF images, audio or music, style sheets or other style parameters, markup language, executable computer programs, data (e.g., JSON data, XML, data, etc.), and/or computer scripts. In one implementation, digital resources also include data structures that describe behaviors associated with the digital resources such as the availability of the user of target computing device application 126 to submit requests, profile information, or other data to other parts of the system as described herein, or to receive notifications from other parts of the system. In another implementation, digital resources include presentation rules for media such as style parameters, colors, or fonts. In another implementation, digital resources include associated metadata to identify the type of information included in the digital resources, the format of the information, and other format-specific information such as width, height, and frame rate presentation parameters.

In an example implementation, a mobile and/or server operating system, various applications (including a geolocation application, and various programs to support communications including an email application, SMS messaging application, data storage, database, and network communications applications, etc.) and other modules and services may be embodied by instructions stored in a memory and/or storage devices and processed by processing unit(s) available on target computing device 116, handheld device 110, point of sale device 108, host server 102, and digital resource specification device 106. Digital resources and other data may be stored in the memory and/or storage devices as a persistent datastore.

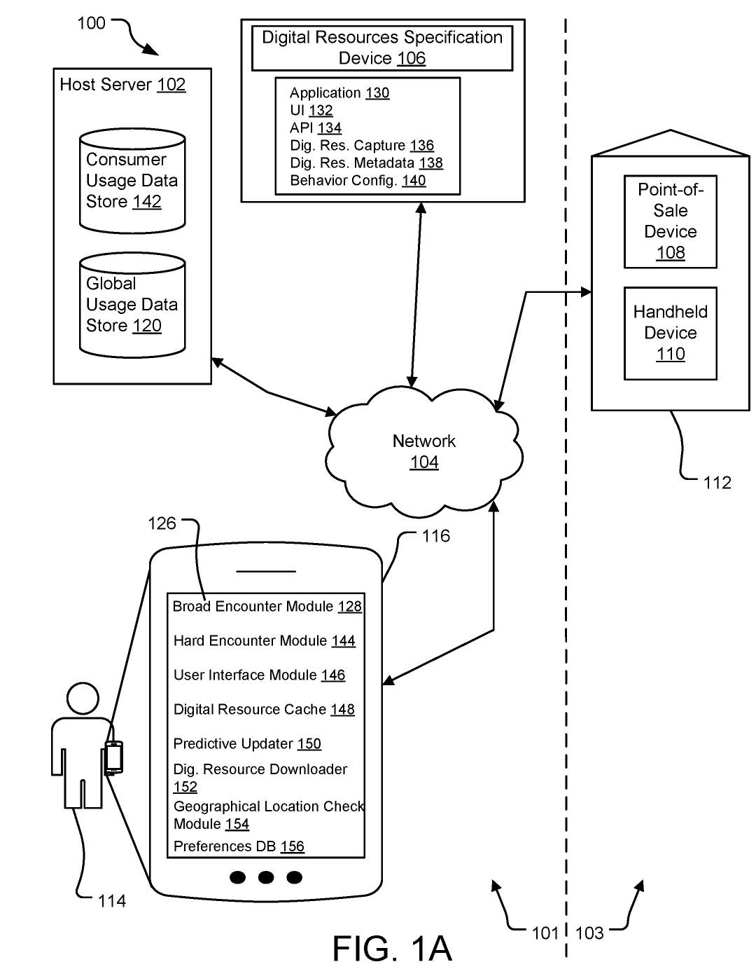

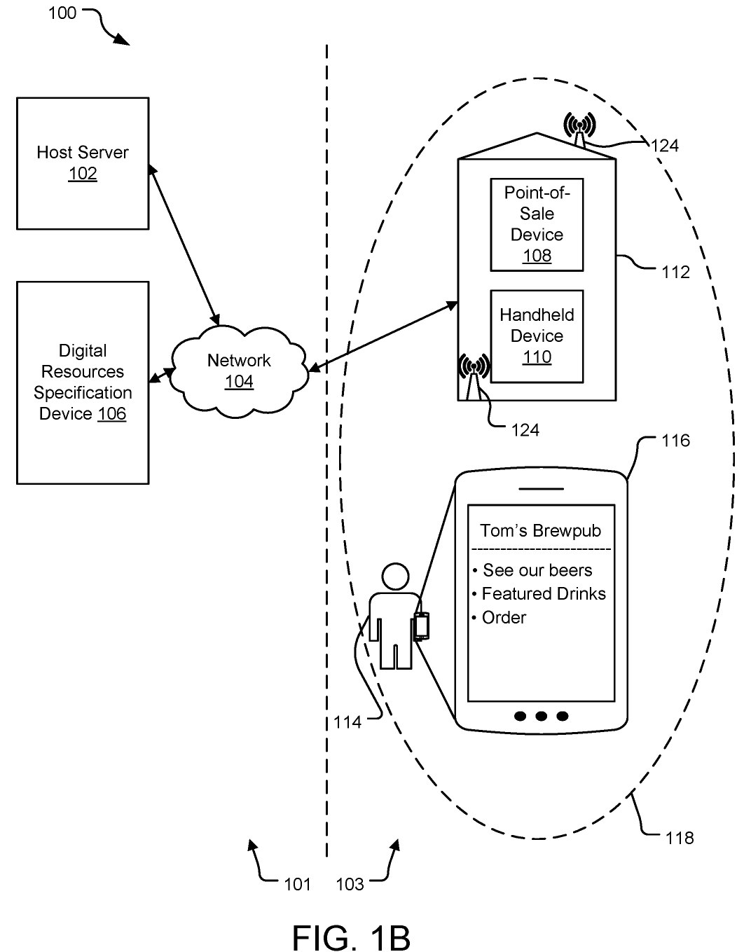

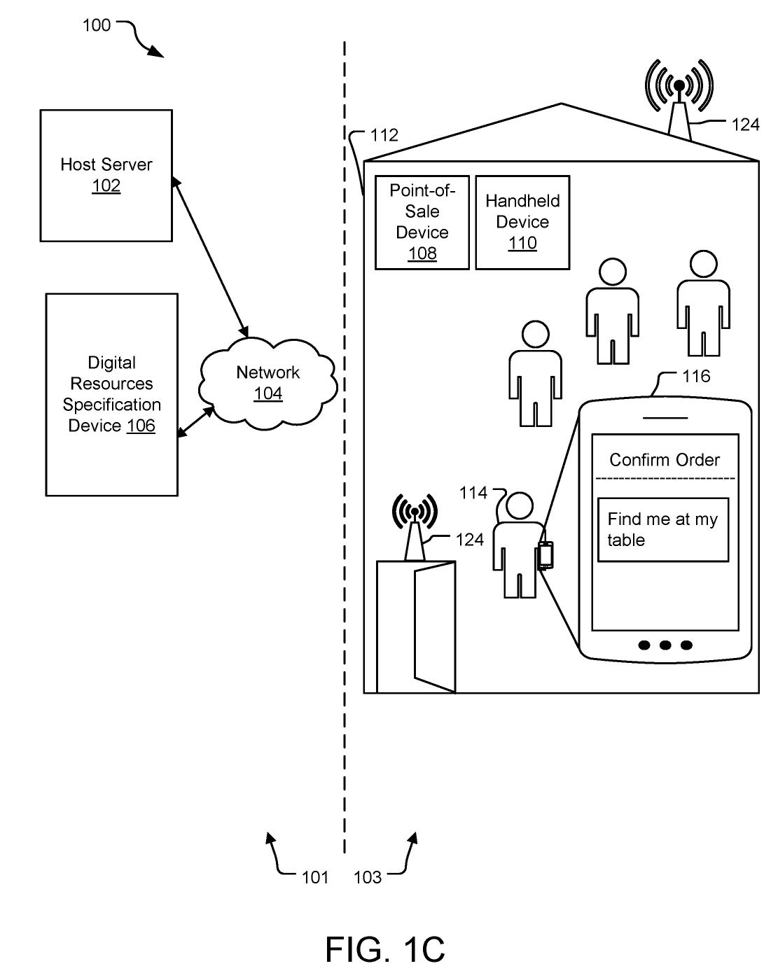

FIGS. 1A-1C illustrate various aspects of an exemplary architecture implementing a location-based digital resource provisioning system 100 also referred to herein as a smart hospitality system. In particular, FIG. 1A illustrates a block diagram of the location-based digital resource provisioning system 100. The high-level architecture includes hardware and software application components and data communications channels for communicating data between the hardware and software components. The provisioning system 100 may be roughly divided into remote components 101 and on-location components 103. The remote components 101 and on-location components 103 of the system may be viewed as interacting with each other to define, configure, provision, and respond to digital resources, and to report summary and statistical data relating to the locations and activities of the provisioned devices. In one implementation, the remote components 101 receive and store digital resources associated with a geographic location 112, and continuously and automatically monitor the location status of target computing device 116 for satisfaction of a location condition with respect to geographic location 112.

The target computing device 116 may supply physical location parameters to the remote components 101. In at least one implementation, the physical location parameters are geo-coordinates of the target computing device 112. In other implementations, the physical location parameters include information that indicate the location of the device such as a sensed wireless hotspot, a sensed beacon, contact with other devices such as through Bluetooth or near-field communications, or analysis of information such as a calendar entry with an associated geographic location or communications indicating intention to be present at the geographical location, also referred to herein as a geographical branding location, at a future time.

When the location condition is satisfied, remote components 101 may provision the target computing device with the digital resources via communications network 104. In one implementation, remote components 101 may predictively cache digital resources on target computing device 116 in digital resource cache 148 based on indications that target computing device 116 is likely to satisfy the geographic location condition with respect to geographical location 112 at a future time. In another implementation, remote components 101 may record interactions between the target computing device 116 and the digital resources on global digital resource data store 120 and provide reports based thereon.

Remote components 101 may be disposed in any location that provides communicative access to communications network 104, which is communicatively coupled to on-location components 103. Communications network 104 may be a proprietary network, a public packet-switched network, the Internet, a virtual private network, a circuit-switched network, a satellite link, or any combination of the foregoing. Remote components 101 include host server 102, and digital resource specification device 106.

Digital resource specification device 106 executes an application running on one or more servers, is communicatively coupled to network 104, and identifies and configures digital resources for later remote provisioning. Digital resource specification application 130 may include a user interface module 132 for managing interactions with a user. In another implementation, it may include an application interface (API) 134 for receiving and sending the digital resources and configurations thereof programmatically.

Digital resource specification application 130 may further include a digital resource capture module 136 for gathering digital resource media from the user. Digital resource specification application 130 may include a resource metadata component 138 to create a list of digital resource behaviors, resource types, formats, and collections of style information. A digital resource behavior configuration module 140 gathers desired digital resource behaviors from a user 114 via the user interface module 132. Digital resource behaviors may include any rules for interacting with user 114 such as menu styles and content for user display, language and other localizations such as currency, date and time, and calendar localizations. Digital resource behaviors may also include the capability for the digital resources to accept requests from user 114 and transmit those requests to host server 102, point-of-sale device 108, handheld device 110, digital resource specification application 130, or any other location on the system. Examples of capabilities to accept requests from the user include, for example: a request to serve hospitality services to user 114 at the user's physical location at geographical location 112; a request to call a taxi to geographical location 112 on behalf of user 114; a request to transmit user 114's receipt for services rendered at geographical location 112 electronically to the user 114 or to another entity; a request that includes a photograph of user 114; a request to deliver a tab for hospitality services rendered to user 114 at the user's physical location at geographical location 112; a request that contains verification information relating to user 114 such as the user's age or legal status; a request that contains preference information relating to user 114 such as the user's preference to drink margaritas without salt; and a request that includes dietary restrictions relating to user 114 such as requirements for a low-salt or vegetarian diet. Once gathered by digital resource capture module 136, the digital resources may be stored in global resource data store 120 (as shown in the implementation of FIGS. 1A-1C), located either locally on digital resource specification application 130 or at host server 102 or on another part of the system disclosed herein.

Digital resource specification device 106 may transmit digital resources and configurations pertaining thereto to host server 102 for storage in global digital resource data store 120. In one implementation, digital resource specification device 106 may house global digital resource data store 120 locally, as well as other data stores including global user usage data store 120 or any other data stores described herein as residing on the host server 102.

In an implementation, digital resource specification device 106 collects digital resources in three phases: a first phase for gathering general information relating to geographical location 112 including the location's physical metes and bounds, information about the types of behaviors included in the digital resources, and identification of the types of media resources or branding resources included in the digital resources; a second phase for defining the details of each desired digital resource behavior; and a third phase for collection of digital resource media with which to provision the target computing devices by host server 102. For example, the first phase may include identifying geo-coordinates of the geographical location 112 and identifying characteristics of Wi-Fi hotspots and beacons present at the geographical location 112. Characteristics of Wi-Fi hotspots and beacons present at the geographical location 112 include Wi-Fi SSID, Wi-Fi mac address, measurements of signal strength at various locations inside the confines of geographical location 112, beacon address, etc. The second phase may include information on when to display first content and second content at the geographical location 112, such as, for example, whether interstitial information should be inserted to identify tours, specials, or other services offered at the geographical location 112. The third phase may include determining specific menus to be shown to the user on a hard encounter, text, images, formatting, video clips, etc. The third phase may include information deemed to be a second content of the digital assets.

The on-location components 103 are primarily disposed in or near geographical location 112, which may be any type of geographical location for which digital resources are associated. Geographical location 112 may include hospitality providers such as hotels, nightclubs, restaurants, bars, social clubs, and performance venues. Geographical location 112 may also include in-person service providers such as museums, public buildings, schools, office buildings, parks, transit stations, or service centers, etc.

On-location components 103 include one or more geographical location devices such as, for example, point-of-sale device 108 and handheld device 110. Implementations of geographical location devices include workstations, mobile devices, desktop computer, smartphones, tablets, or any other electronic device suitable for executing the geographical location applications described herein, and performing network communications and user interactions to allow geographical location personnel (not shown) to access images and information as described herein. One or more of the geographical location devices 108, 110 may be excluded and the functions of the excluded device consolidated on other of the geographical location devices. Implementations also include addition of one or more additional geographical location devices (not shown) that may perform capabilities of geographical location devices 108, 110 as described herein, such as a wearable device (e.g., a watch, electronic clothing accessory such as a bracelet), a television, etc. On-location components 103 may also include user 114 and associated target computing device 116. Like point-of-sale device 108 and handheld device 110, implementations of target computing device 116 may include a mobile device, desktop computer, smartphone, tablet, wearable, or any other electronic device suitable for executing the target computing device applications described herein including processing, storing, and transmitting data. Target computing device 116, point-of-sale device 108, handheld device 110, and any other geographical location devices communicate with remote components 101 via the communications network 104.

User 114 may be an independent actor who moves into and out of the vicinity of geographical location 112, including into and out of a broad detection zone 118. Broad detection zone 118 is a physical area that may be used to identify a “broad encounter” between a user 116 and a geographical location 112. A broad encounter may indicate that a user is in the general vicinity of geographical location 112 such that there is a potential for the user to actually arrive at the geographical location 112. The likelihood of a broad encounter occurring may be further refined according to information known about the user. For example, services available on the target computing device 116 may include the user's historical interactions with a particular geographical location 112. If the user is a frequent visitor to a particular geographical location 112, then the likelihood of identifying a broad encounter with the geographical location 112 may be increased. In other implementations, the likelihood of a broad encounter may be elevated if contacts in the user's address book have communicated with the user regarding the geographical location 112, if there is a calendar entry in the user's calendar mentioning the geographical location 112, if the user 114 has indicated on a social media platform that the user 114 is interested in subject matter related to the geographical location 112 (e.g., a broad encounter with a rock music-themed restaurant is more likely if the user 114 has indicated a preference for rock music, rock musicians, has attended rock concerts in the past, etc.) In one implementation, a broad encounter satisfies a first location condition.

A hard encounter, also referred to as a high-probability encounter, on the other hand, is closer, for example indicating that a user is on or near the premises of a geographical location 112 or close enough to be influenced by digital resources pertaining to that location. In an implementation, geographical location 112 is a hospitality provider and the digital resources are branding materials related to its business. A hard encounter in this implementation may occur when the user is close enough to the hospitality provider to be exposed to branding materials physically present at the hospitality provider. In another implementation, the determination of exposure to physical branding materials or the nearness needed for a hard encounter may be based on the density of locations similar to geographical location 112. In the implementation of a hospitality provider, the hard encounter distance may be reduced in areas of high density for other hospitality providers of the same type (bars, restaurants, clubs, etc.). In one implementation, a hard encounter satisfies a second location condition.

Detecting a hard encounter between target computing device 116 may be accomplished by a short range wireless beacon detector on the target device. In an implementation, a short-range wireless Bluetooth low-energy (BLE) beacon detector identifies and reports on wireless BLE beacons 124 stored within geographical locations 112. Wireless beacons 124 are registered with the specific geographical location 112 and are labeled according to their positioning within geographical location 112. Implementations include labeling wireless beacons 124 as an entry beacon or an identification beacon where the identification marks a feature of geographical location 112 such as a bar, a stage, restrooms, a beer garden, a patio, or portions of a seating area. The short-range wireless beacon detector reports beacons detected, the approximate distance to the beacon, the type of beacon, its label, or other location pertaining to the beacon's location inside geographical area 112. Location may be reported based on a comparison of the differential power of multiple of the beacons and triangulating based on known locations of the beacons. Implementations also include location detection within geographical location 112 based on relative strength of Wi-Fi signals or Wi-Fi signals in combination with beacons or other transmitters.

With reference to FIGS. 1A-1C, an exemplary target computing device is shown executing a target computing device application 126 including a broad encounter module 128 for scheduling downloads of digital resources, a hard encounter module 144 for detecting when target computing device 116 is located within the metes and bounds of a geographical location 112, a target computing device user interface module 146 for displaying or otherwise communicating digital resources to user 114 and accepting input from user 114, a digital resource cache 148 for storing downloaded digital resources, a predictive cache updater module 150 for scheduling sets of digital resources based on intelligent prediction to make them available to user 114 on demand without forcing user 114 to wait for the download to complete if his location quickly changes such that it creates an encounter with geographical location 112, and a digital resource downloader module 152 for performing downloads of digital resources from host server 102.

Predictive cache updater module 150 may be triggered by broad encounter module 128 to decide if a geographical location 112 that is nearby should have its associated digital resources cached so the target computing device application can quickly adapt to the new resources if the user 114 enters geographical location 112. Implementations include wherein predictive cache updater 150 uses statistics from consumer usage data store 142 to determine the probability of user 114 entering geographical location 112. If the probability is beyond a threshold, predictive cache updater 150 triggers or schedules a download of the digital resources associated with geographical location 112.

Detection of a broad encounter may be used by host server 102 to schedule download of digital resources from host server 102 including from global data store 120 to target computing device 116 in advance of a potential “hard encounter” between user 116 and geographical location 112. Broad and hard encounters may be detected in a number of ways including an implementation wherein the target computing device application 126 includes a location detection that uses services available on target computing device 116 to target computing device application 126 to provide an approximation of the device's location. A geographical location check module 154 may periodically poll host server 102 to ensure that digital resources have been downloaded and saved in digital resource cache 148 for any nearby (i.e. broad encounter) geographical locations 112. If the digital resources of any nearby geographical locations 112 are not in digital resource cache 148, then target computing device application 126 may request them from host server 102.

A hard encounter module 144 may periodically check the location of the target computing device 116 for any geographical locations 112 that are close enough to be considered hard encounters, and may transit the hard encounter information to host server 102 for use in updating global usage data store 120 with hard encounter statistics. Predictive cache updater module 150 uses the encounter information and data available from global usage data store 120 to schedule digital resource downloads to be performed by digital resource downloader 152. Predictive cache updater module 150 may schedule downloads in other ways as well.

In one implementation, the predictive cache uploader module 150 relies on the age and frequency of past updates to digital resources associated with a particular geographical location 112 in local digital resource cache 148. For example, geographical locations 112 with associated digital resources that are frequently or regularly encountered by the user 114 may be scheduled for digital resource downloads even if the target computing device is not currently experiencing a broad or hard encounter with the geographical location because that geographical location is likely to be encountered again in the future by the target computing device 116.

In other implementations, predictive cache update module 150 may schedule a download of digital resources for a geographical location 112 to be performed by digital resource downloader module 152 under any of the following conditions: if a calendar application on target computing device 116 contains a calendar entry for an event at geographical location 112; if target computing device 116 detects a Wi-Fi SSID associated with geographical location 112; if the GPS receiver on target computing device 116 reports a location deemed to be an encounter with geographical location 112 (e.g., within the metes and bounds or within broad zone 118 of geographical location 112); if the cellular antenna on target computing device 116 triangulates a location deemed to be an encounter with geographical location 112; if a person who is a contact in an address book application, social media platform, or communications application on target computing device 116 has had an encounter with geographical location 112; or if a person who is a contact in an address book, social media platform, or communications application has placed a service order or otherwise interacted with digital resources associated with geographical location 112. When a hard encounter with a geographical location 112 has been identified, target computing device user interface module 146 adapts to present the digital resources, including media and behaviors, associated with the geographical location 112 to user 114.

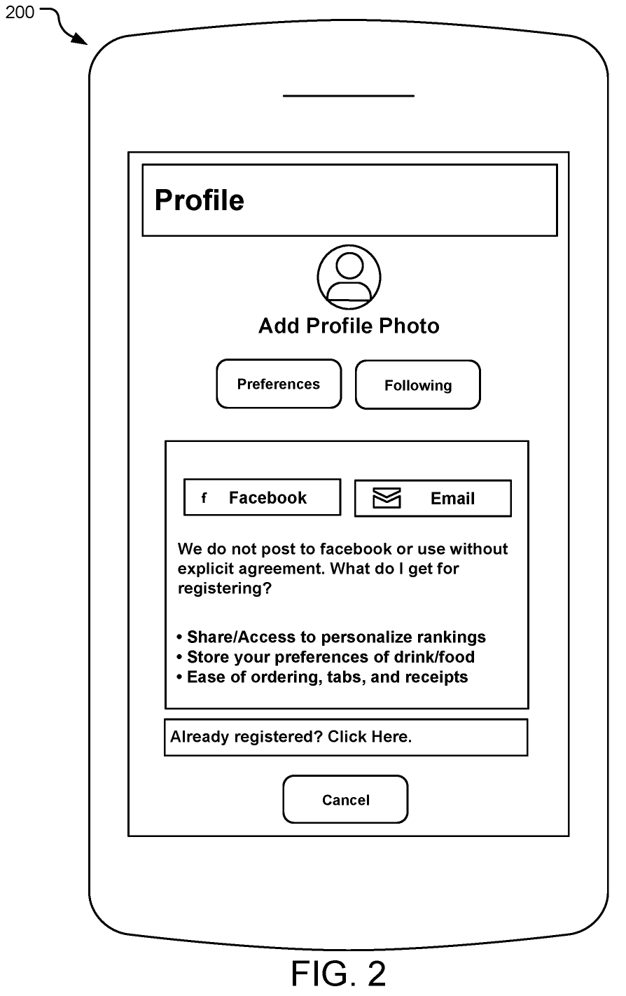

In implementations, the user interface 146 of the target computing device 116 modifies its presentation to the user when it is determined that target computing device 116 has made a hard encounter with geographical location 112. For example, the target computing device may present a second content to the user upon detection of the hard encounter. In one implementation, digital resources cached in digital resource cache 148 are transferred to device preferences database 156 for format translation to accommodate digital resource behaviors before presentation to the user. Such modification is illustrated in FIGS. 1A-1C. Target computing device in FIG. 1A is illustrated to show the various aspects of target computing device application 126 and does not illustrate the presentation of digital resources to user 114. FIG. 1B illustrates digital resources downloaded by downloading module 152 after target computing device 116 has crossed the boundary of zone 118 and thus created a broad encounter with geographical location 112. Although FIG. 1B illustrates the digital resources resident in digital resource cache 148 on target computing device 116, the digital resources are not necessarily displayed to the user when the user is inside zone 118 but outside the confines of geographical location 112. For example, a first content may be displayed to the user then the user is outside zone 118, and a second content may be displayed to the user when the user is inside zone 118. Whether the digital resources are presented to user 114 in this scenario depends on the configuration of the digital resources as stored, in an implementation, in digital resources metadata module 138 on digital resources specification application 130. FIG. 1C illustrates user 114 inside the confines of geographical location 112, and thus in a hard encounter with geographical location 112. FIG. 1C further illustrates presentation of digital resources to user 114 via UI module 146 on target computing device application 126. Further aspects of the presentation of digital resources to user 114 are described herein with references to FIGS. 2-13 of the present application.

Implementations of host server 102 include reporting capabilities of summarized and statistical information regarding selected digital resources in the system and other type of data sets including user usage data. Implementations include summarized information on digital resource media usage including length of text, language(s) used, font usage, size of images, and usage of video and audio by individual users or groups of users. In other implementations, the data sets may include statistics on user behavior choices organized by geographical territory, such as geographical locations 112 that permit certain payment options. In still other implementations, user visit statistics for specification geographical locations 112 may be provided including by day of the week, hour of the day, or other time-based metrics. In still other implementations, user hard or broad encounter statistics may be provided or combined user visit and encounter data sets such as the ratio of encounters that resulted in at least one completed purchase.

FIG. 2 depicts a new profile screen 200 of an example target computing device application. New profile screen 200 is the entry point if user 114 does not have an existing user account on the system. Screen 200 provides an opportunity to add a user photo, the ability to add key preferences regarding in-person services, and the ability to link to other users 114 on the system, such as contacts with whom the user 114 is connected on social media platforms, contacts in an address book belonging to the user 114, etc.

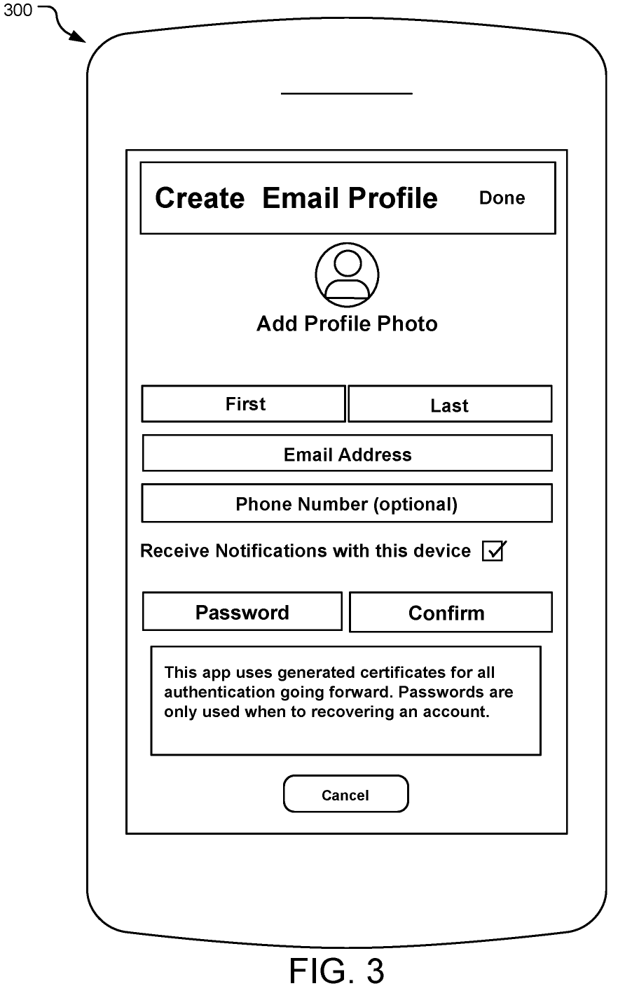

FIG. 3 depicts a profile setup screen 300 of an example target computing device application. Profile setup screen 300 accepts user credentials, which may be accomplished according to a user name and password or according to a certificate based on proof of ownership of private identity keys corresponding to a public identity key. The certificate may be provided by a trusted third party or the authenticity of the certificate may be determined according to communications between user 114 and host server 102.

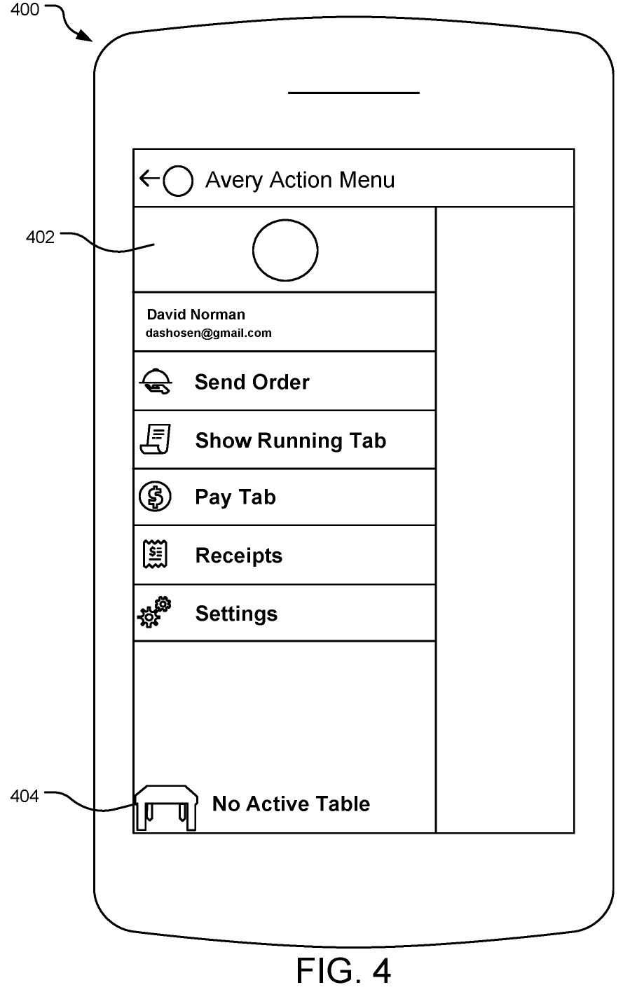

FIG. 4 depicts a navigation screen 400 of an example target computing device application. Navigation screen 400 provides navigation buttons and may present digital assets 402 to user 114 based on user 114's present location. Digital asset 404 indicates the current location of user 114 within the confines of geographical location 112 if it is known. Digital asset 404 may also include images, formatted text, video, special services available at the geographic location (taxi services, child care, take out service, reservation service, etc.). In at least one implementation, digital asset 404 may be based on historical information collected over time from the user's prior interactions with one or more geographical locations. For example, if the user has a history that includes a high likelihood of ordering beer as a beverage, the digital asset 404 may include a button for a beer menu. If the user has a history that includes a high likelihood of ordering an appetizer, then the digital asset 404 may include a button for an appetizer menu.

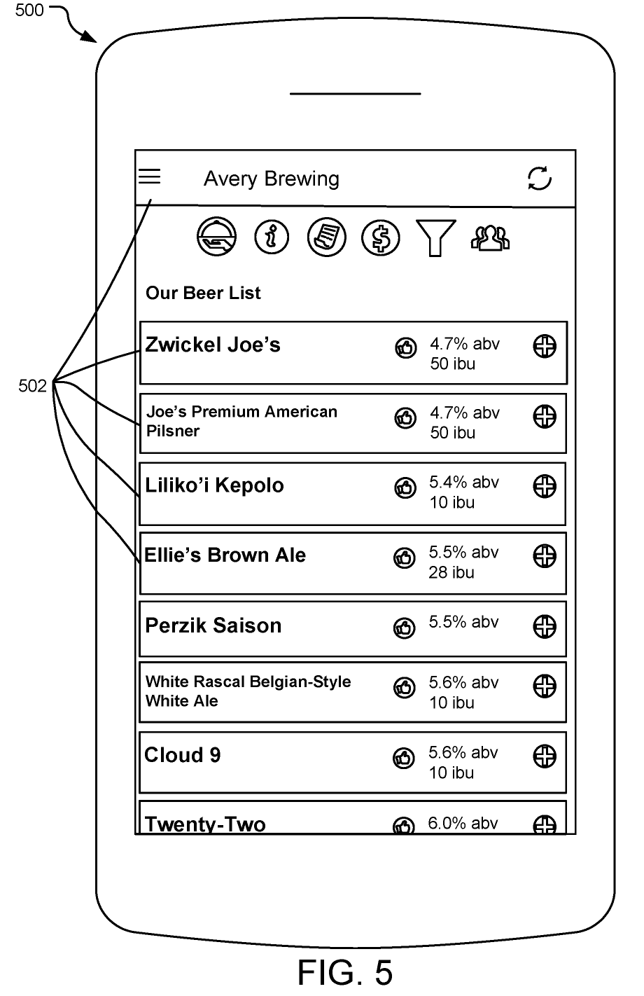

FIG. 5 depicts an inventory list screen 500 of an example target computing device application. Inventory list screen 500 presents digital assets 502 to user 114 specific to a particular geographical location 112. In an implementation, inventory list screen 500 may present inventory information (e.g., beer styles, barrel age, etc. at a brewery) to user 114 or other information regarding goods and services available to guests at geographical location 112.

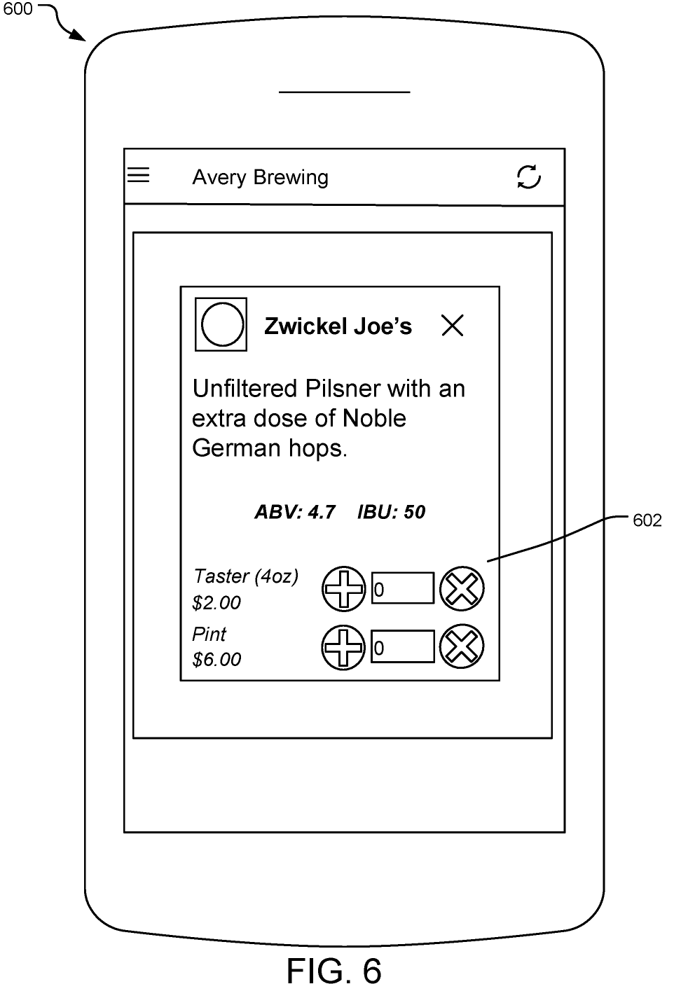

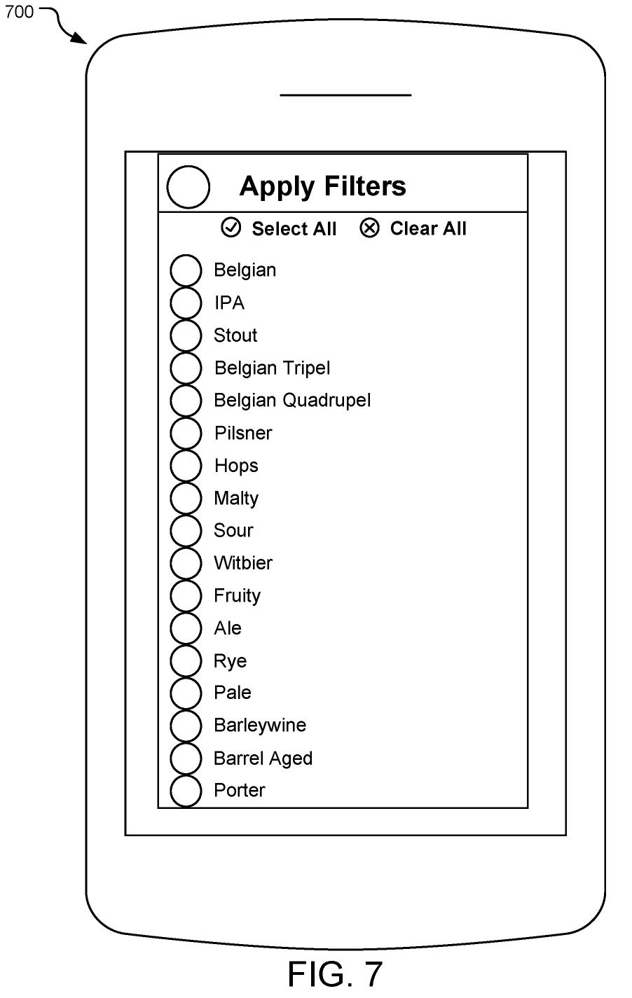

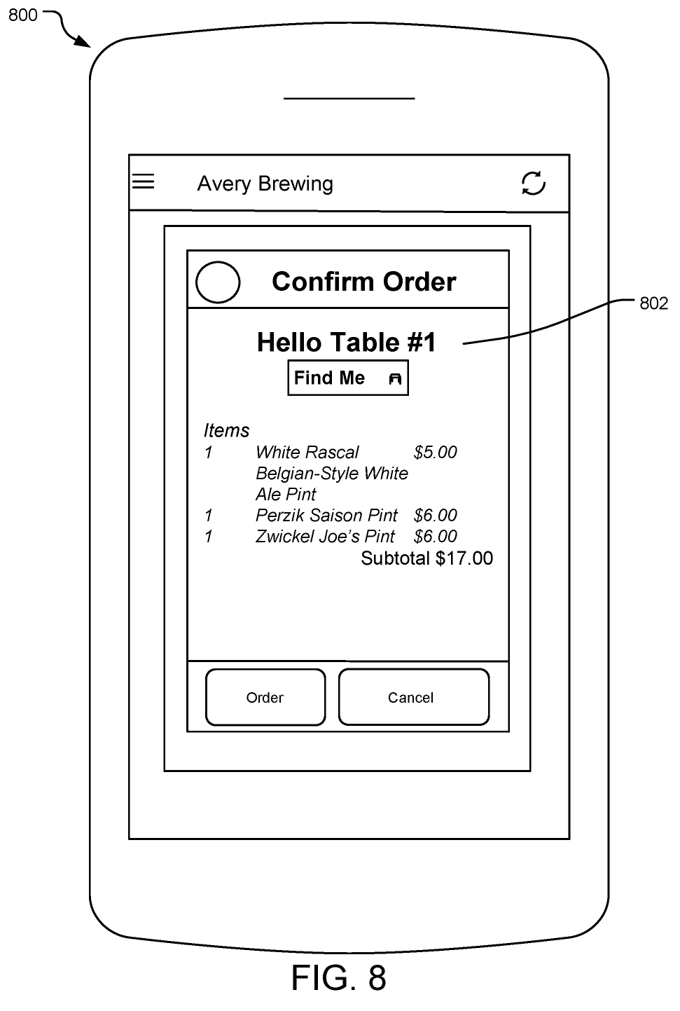

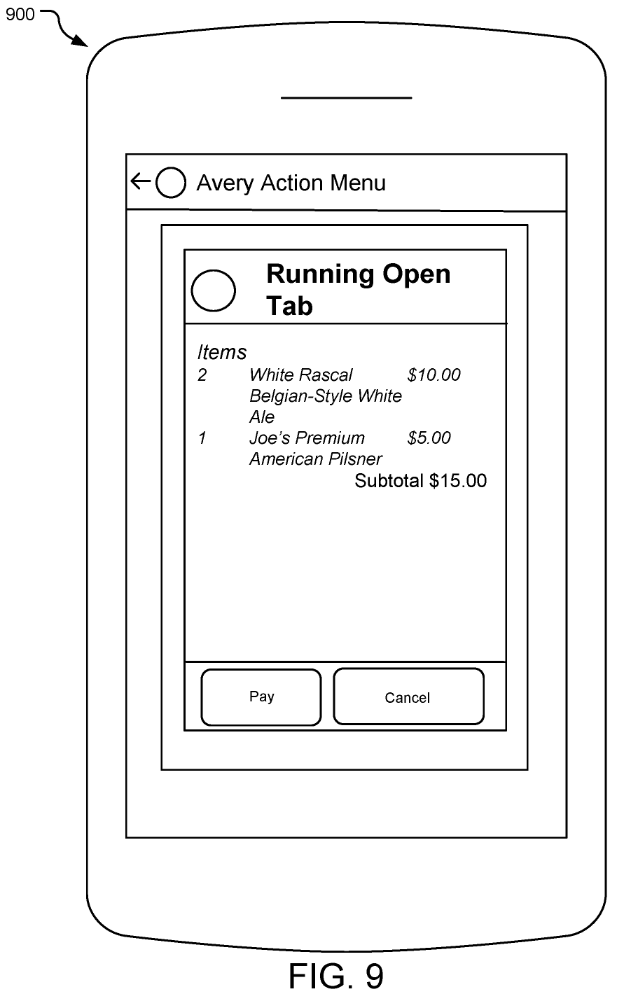

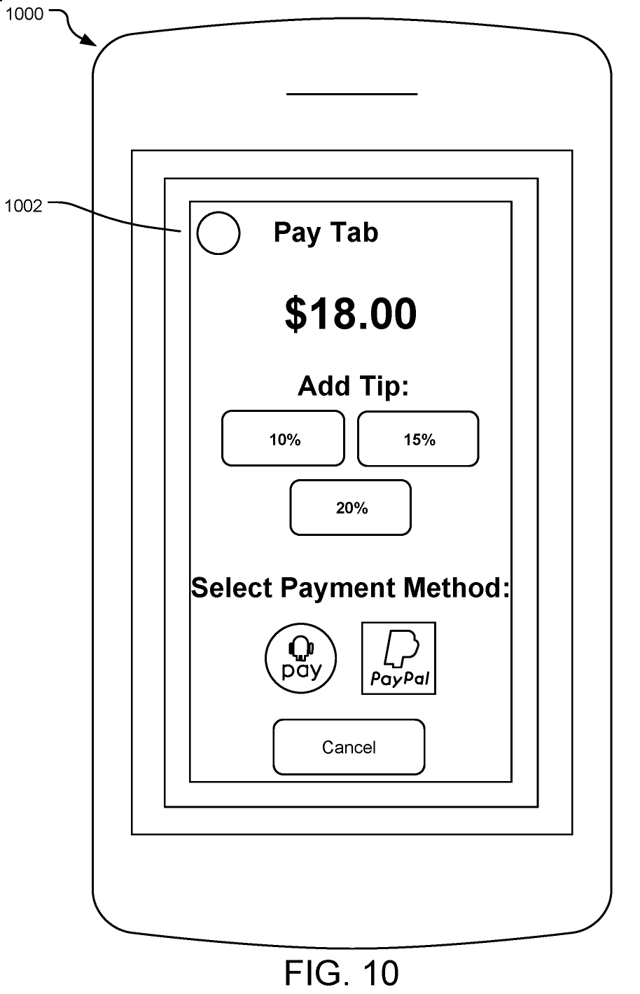

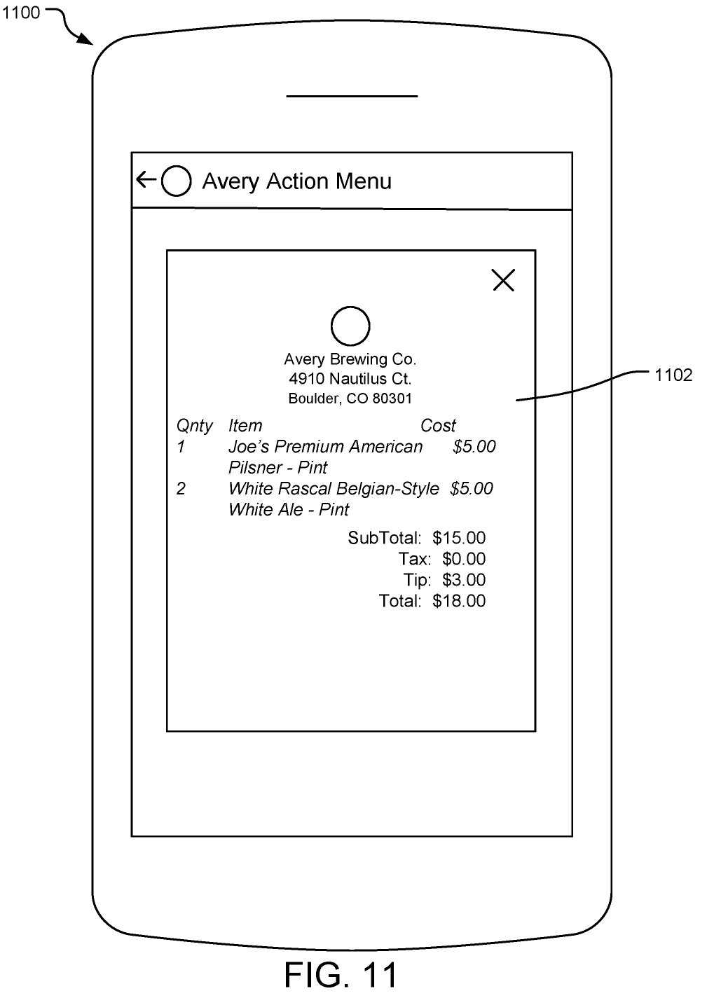

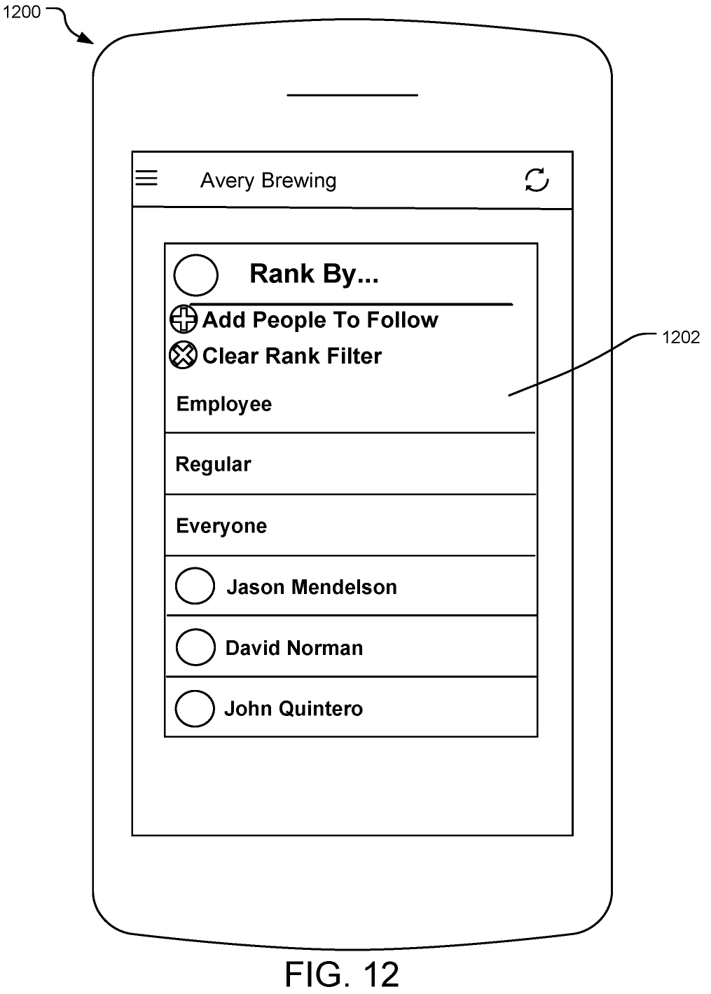

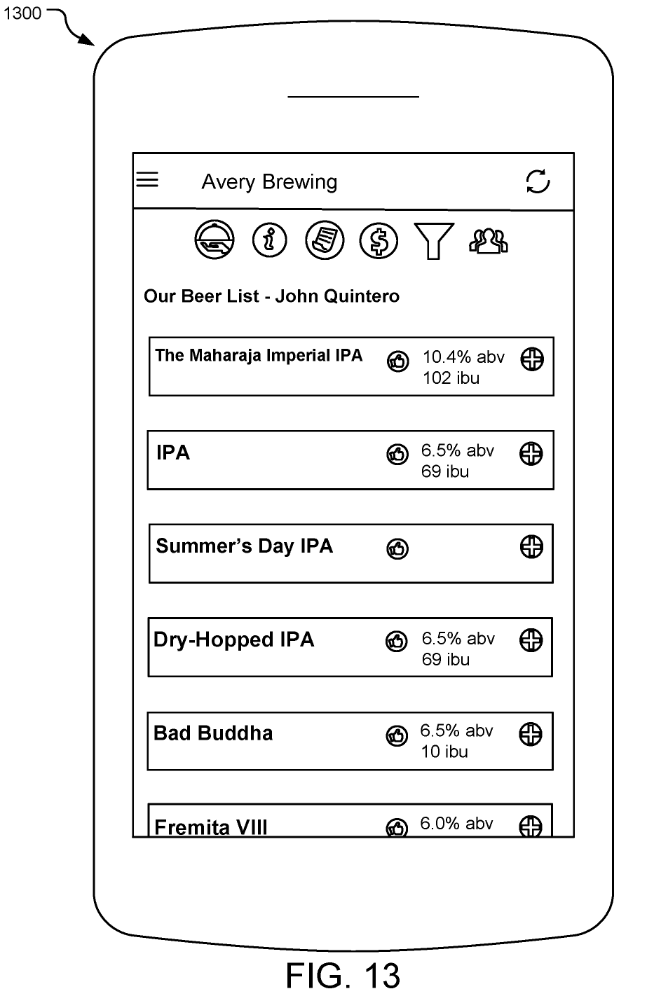

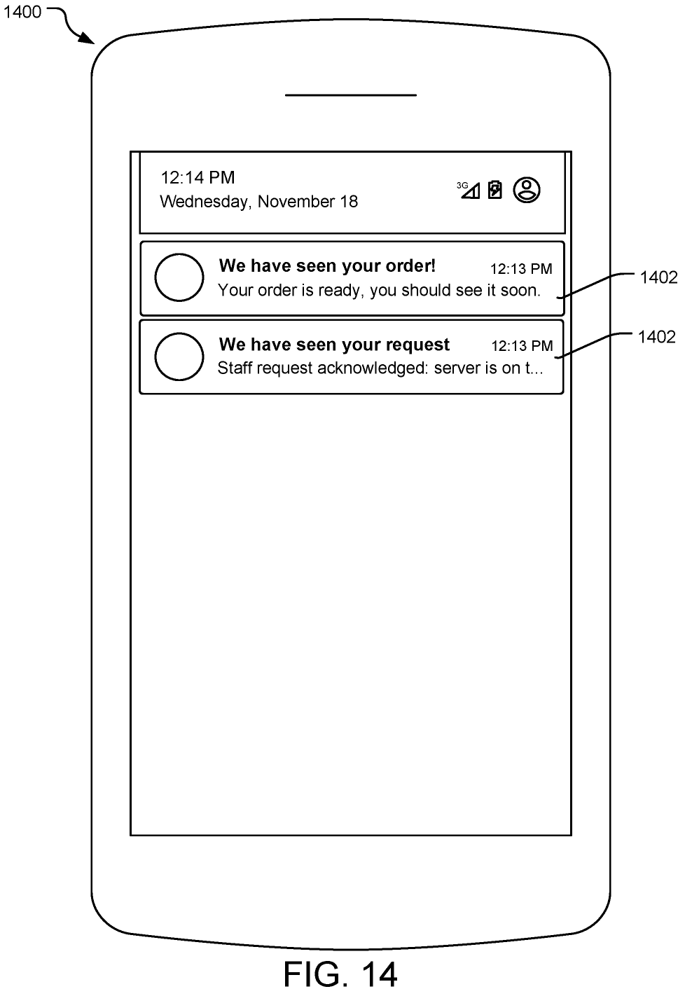

FIG. 6 depicts an inventory description screen 600 of an example target computing device application. Inventory description screen 600 provides interactions with digital resources 602. In an implementation, inventory description screen 600 provides access to additional information regarding inventory items, or customizable options regarding inventory items, presented to the user on inventory list screen 500. FIG. 7 depicts a filter screen 700 of an example target computing device application. FIG. 8 depicts an order screen 800 of an example target computing device application. Order screen 800 may contain digital resources 802 reflecting location of user 114 within the confines of geographical location 112 if it is known. Digital resource 802 may also be interactive with respect to the user. In an implementation, digital resource 802 may cause a message to be sent to point-of-sale device 108, handheld device 110, or any other device in the system that user 114 wishes to interact with physically located within geographical location 112. FIG. 9 depicts a running tab screen 900 of an example target computing device application. FIG. 10 depicts a tab payment screen 1000 of an example target computing device application containing digital resource 1002. FIG. 11 depicts an example receipt screen 1100 of a target computing device application. Screen 1100 contains digital resource 1102 that may present messages specific to a particular user 114. FIG. 12 depicts social networking screen 1200 of an example target computing device application. Screen 1200 may present digital resource ranking 1202, which is a list based on social selections of individuals or selections unique to geographical location 112. FIG. 13 depicts social ranking screen 1300 of an example target computing device application. FIG. 14 is a digital resource message received screen of an example target computing device application including digital resource messages 1402.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

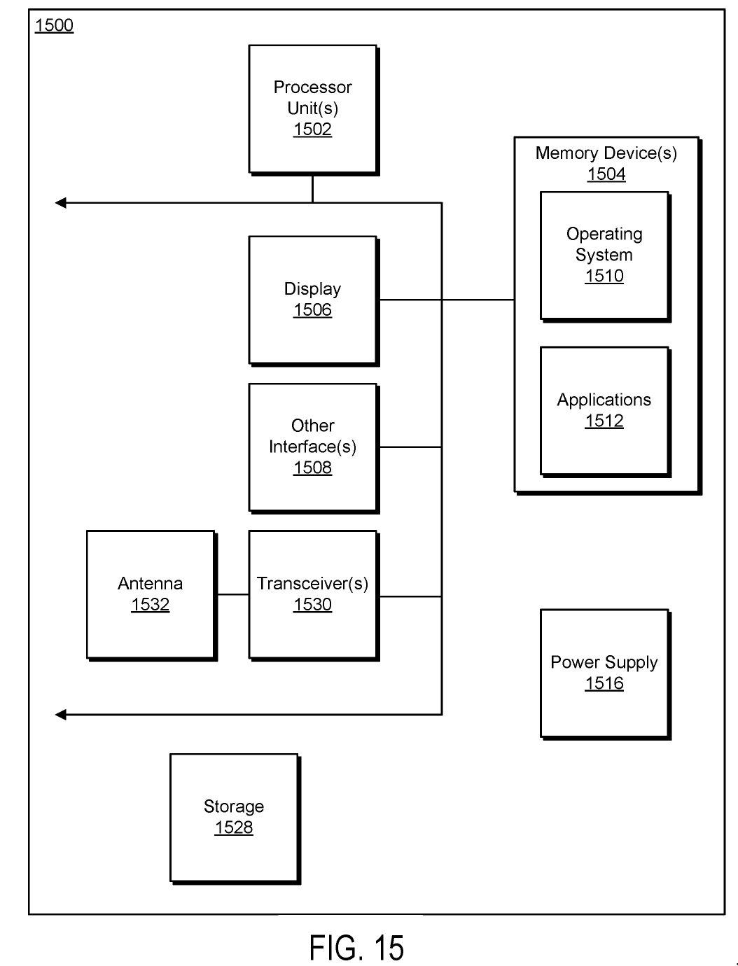

FIG. 15 illustrates an example schematic of a target computing device 1500 suitable for being provisioned with digital resources according to the herein described technology. The example target computing device 1500 includes one or more processor units 1502, one or more memory devices 1504, a display 1506 (e.g., a touchscreen or conventional display), and other interfaces 1508 (e.g., switches or buttons). The memory 1504 generally includes both volatile memory (e.g., RAM) and non-volatile memory (e.g., flash memory). An operating system 1510 resides in the memory 1504 and is executed by the processor unit(s) 1502, although it should be understood that any operating systems may be employed. One or more applications 1512, such as a broad encounter module, a hard encounter module, a request module, programs to support geolocation and communication circuitry, are loaded in the memory device 1504 and executed on the operating system 1510 by the processor(s) 1502.

The example computing device 1500 includes a power supply 1516, which is powered by one or more batteries or other power sources and which provides power to other components of the computing device 1500. The power supply 1516 may also be connected to an external power source that overrides or recharges the built-in batteries or other power sources.

The computing device 1500 includes one or more communication transceivers 1530 and an antenna 1532 to provide network connectivity (e.g., a mobile phone network, Wi-Fi®, BlueTooth®, etc.). The computing device 1500 may also include various other components, such as a positioning system (e.g., a global positioning satellite transceiver), one or more accelerometers, one or more cameras, an audio interface, and additional storage 1528. Other configurations may also be employed.

The computing devices referred to herein (host server 102, digital resource specification device 106, handheld device 110, point of sale device 108, target computing device 116, example target computing device 1500, etc.) may include a variety of tangible computer-readable storage media and intangible computer-readable communication signals. Tangible computer-readable storage can be embodied by any available media that can be accessed by the above-referenced devices and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the above-referenced devices. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

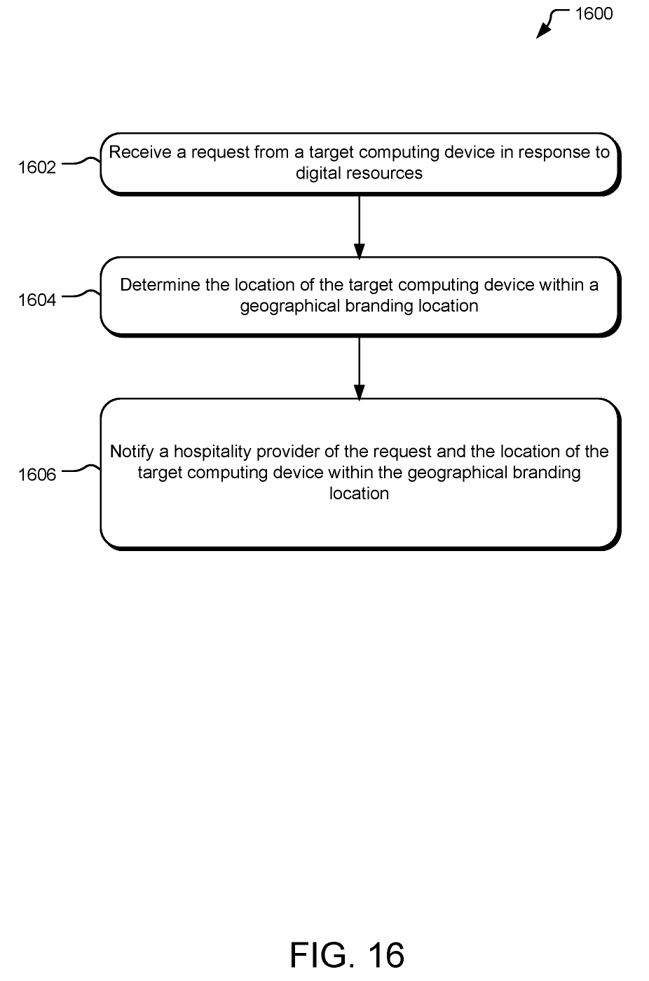

FIG. 16 illustrates example operations 1600 for location-based provisioning of digital resources. A receiving operation 1602 receives a request from a target computing device in response to digital resources. The digital resources in operation 1602 may include an invitation to a user of the target computing device to make a request, such as a request for hospitality services. A determining operation 1604 determines the location of the target computing device within a geographical branding location. The determining operation may be carried out in a variety of ways. In at least one implementation, the request from the target computing device received in operation 1602 includes location information identifying a portion of the geographical branding location as the location of the target computing device. The location information identifying a portion of the geographical branding location may be based on signals received by the target computing device. For example, the target computing device may measure the signal strength from one or more beacons or Wi-Fi hotspots located inside the geographical branding location. Further, the target computing device may triangulate its position based on the relative strength of signals from one or more beacons or Wi-Fi hotspots located inside the geographical branding location and transmit the position to be received in operation 1602.

A notifying operation 1606 notifies a hospitality provider of the request and the location of the target computing device within the geographical branding location. The notifying operation 1606 may include a message to be displayed on a geographical location device associated with the hospitality provider (e.g., a tablet, watch, smartphone, etc. carried by wait staff, hostess, etc. In another implementation, the notifying operation may include display of the request and location of the target computing device on a computer monitor, television screen, etc. The notifying operation may further include the location of the target computing device by reference to a portion of the geographical branding location (e.g., the bar, pool table area, the table at which the user of the target computing device is seated, a patio, etc.).

An example implementation of the system described herein includes a non-transitory computer readable medium comprising computer executable instructions to cause a processor to perform the steps of receiving, at one or more host servers, one or more signals representing digital resources selected by a hospitality provider and associated with a geographical branding location; saving the digital resources at a storage coupled to the one or more host servers; repeatedly receiving, at the one or more host servers, physical location parameters from a target computing device; automatically, at the one or more host servers, in response to first physical location parameters received from the target computing device, retrieving the digital resources associated with the geographical location from the storage wherein the first physical location parameters meet a threshold with respect to the geographical location; and scheduling a download of the digital resources from the one or more host servers to the target computing device.

An example system of any previous system includes wherein the digital resources include one of: multimedia assets, presentation style parameters, presentation behaviors, and formatting parameters. Another example system of any previous system includes wherein the presentation behaviors include one or more of the following: a text menu display for presentation to the mobile device user; or language localizations.

An example method for location-based provisioning of digital resources includes receiving, at one or more host servers, digital resources selected by a hospitality provider, the digital resources being associated with a geographical branding location, saving the digital resources at a storage, repeatedly receiving, at the one or more host servers, physical location parameters from a target computing device, automatically retrieving, at the one or more host servers, in response to first physical location parameters received from the target computing device, the digital resources associated with the geographical branding location from the storage if the first physical location parameters satisfy a location condition, and transmitting the digital resources to the target computing device if the first physical location parameters satisfy the location condition.

An example method of any preceding method includes updating, at the one or more host servers, a global usage data store reflecting the recognized hard encounter between the mobile device and the geographical branding location.

Another example method of any preceding method includes wherein the digital resources include presentation behaviors. Another example method of any preceding method includes wherein the presentation behaviors include one or more of the following: a menu display for presentation to the mobile device user; or localization settings.

Another example method of any preceding method includes wherein the first physical location parameters meet the threshold if one or more of the following conditions are satisfied: the mobile device's calendar contains a calendar entry for an event at the geographical branding location; the mobile device detects a Wi-Fi SSID associated with the geographical branding location; the mobile device's GPS reports a location within a predetermined distance from the geographical branding location; the mobile device's cellular antenna triangulates a location within a predetermined distance from the geographical branding location; a contact of the mobile device user has had an encounter with the geographical branding location; a contact of the mobile device user has placed a service order at the geographical branding location; the mobile device user has sent a text or email message including the geographical branding location; and the mobile device user has requested travel directions to the geographical branding location.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed is:

1. A system for location-based provisioning of digital resources, the system comprising:
one or more host servers having a processor configured to execute a host process, the one or more host servers being configured to receive via a communication network physical location parameters from a target computing device having one or more location sensors; and
the host process being configured to cause the transmission of digital resources to the target computing device via the communication network if the physical location parameters satisfy a first location condition, the digital resources configured to present a first content on the target computing device if the first location condition is satisfied and to present a second content on the target computing device if a second location condition is satisfied.

2. The system of claim 1, wherein the first location condition is satisfied if the physical location parameters indicate a physical location within a first predetermined distance from a geographical branding location and the first content includes information regarding the geographical branding location.

3. The system of claim 2, wherein the second location condition is satisfied if the physical location parameters indicate a physical location within a second predetermined distance from geographical branding location and the second content includes a user interface configured to accept a request from a user of the target computing device, the second predetermined distance being less than the first predetermined distance.

4. The system of claim 1, wherein the physical location parameters satisfy the second location condition if at least one of the following is true: the target computing device detects a Wi-Fi hotspot associated with a geographical branding location, a beacon associated with the geographical branding location, and the physical location parameters include a physical location within a second predetermined distance from the geographical branding location.

5. The system of claim 3, wherein:
the target computing process is further configured to accept a request from a user of the target computing device in response to the second content.

6. The system of claim 5, wherein the request includes a request for a hospitality provider to locate the user of the target computing device at the geographical branding location.

7. The system of claim 3, further comprising:
a geographical location device configured to execute a geographical location process, the geographical location device being communicatively coupled to the communication network;
the digital resources including permission for the target computing process to transmit a request to the geographical location process via the communication network; and
the geographical location process being configured to receive the request from the target computing device process via the communication network and to display information contained in the request on the geographical location device.

8. The system of claim 5, wherein the request includes one or more of the following: a request to serve hospitality services to the user of the target computing device; a request to call a taxi on behalf of the user of the target computing device; a request to transmit the target computing device user's receipt for hospitality services electronically; and a request to deliver a tab for hospitality services to the user.

9. The system of claim 5, wherein:
the second content includes one or more offers of hospitality services based on hospitality services ordered by contacts of the user of the target computing device.

10. The system of claim 1, wherein the physical location parameters include a current physical location of the target computing device sensed by the one or more location sensors.

11. The system of claim 1, wherein the first content and the second content are transmitted to the target computing device simultaneously.

12. A method for location-based provisioning of digital resources, the method comprising:
receiving a request from a target computing device in response to digital resources received by the target computing device, the digital resources being associated with a geographical branding location;
determining the location of the target computing device within the geographical branding location; and
notifying a hospitality provider of the request and the location of the target computing device within the geographical branding location.

13. The method of claim 12, wherein the determining operation is based on input collected from a user of the target computing device via a user interface.

14. The method of claim 12, wherein the determining operation is based on at least one of Wi-Fi hotspot SSID, Wi-Fi hotspot signal strength, and Wi-Fi hotspot address located within the geographical branding location sensed by the target computing device.

15. The method of claim 12, wherein the determining operation is based on signal strength of a beacon located within the geographical branding location sensed by the target computing device.

16. The method of claim 12, further comprising alerting the target computing device of the completion of the notifying operation.

17. The method of claim 12, wherein the determining operation includes classifying the location of the target computing device as one of a plurality of predetermined physical locations within the geographical branding location.

18. One or more tangible processor-readable storage media embodied with instructions for executing on one or more processors and circuits of a device a process for location-based provisioning of digital resources, the process comprising:
transmitting physical location parameters to a server;
receiving digital assets from the server, the digital assets having a first content and a second content;
presenting the first content to a user of the device if the physical location parameters satisfy a first location condition; and
presenting the second content to the user of the device if the physical location parameters satisfy a second location condition.

19. The tangible processor-readable storage media of claim 18, the instructions further comprising:
wherein the first location condition is satisfied if the physical location parameters indicate a physical location within a first predetermined distance from a geographical branding location and the first content includes information regarding the geographical branding location;
wherein the second location condition is satisfied if the physical location parameters indicate a physical location within a second predetermined distance from geographical branding location and the second content includes a user interface configured to accept a request from a user of the target computing device, the second predetermined distance being less than the first predetermined distance.

20. The tangible processor-readable storage media of claim 19, the instructions further comprising:
detecting a location of the device within the geographical branding location; and
transmitting the location of location of the device within the geographical branding location to the server.
